(19) United States
(12) Patent Application Publication
(10) Pub. No.: US 2004/0203921 A1
(43) Pub. Date: Oct. 14, 2004

(54) Sub-sector timing advance positions determinations

(76) Inventors: Nicholas Bromhead, Thornbury (AU); Matthew Neil McCarthy, Balgownie (AU)

Correspondence Address: James A. Harrison, P.O. Box 670007, Dallas, TX, 75367, US

(21) Appl. No.: 10/394,527

(22) Filed: Mar. 21, 2003

(51) Int. Cl. H04Q 7/20

(52) U.S. Cl. 455/456.1; 455/444; 455/446

(57) ABSTRACT

A method and apparatus are provided for reporting the latitude and longitude of a mobile station through the use of a network-only solution. The mobile station's range from a controlling base transceiver station is calculated from sub-sector timing advance signal data. The mobile station is assigned an initial mobile station bearing equal to a radial center of the serving sector azimuth bearing of a tri-sectored cell site. The mobile station reports forward link pilot signal power measurements for the two sectors adjacent to the serving sector of the controlling base transceiver station. The base station determines if a difference of the reported power measurements exceeds a specified threshold and mathematically adjusts the initial mobile station bearing by a bearing step size. In one embodiment, the bearing is changed from the center to 30° from the center if the reported power difference exceeds 15 dB.

### BACKGROUND OF THE INVENTION

1. Technical Field of the Invention

The present invention relates to communication networks and, more particularly, to wireless communication networks.

2. Description of Related Art

The structure and operation of wireless communication systems are generally known. Examples of such wireless communication systems include cellular systems and wireless local area networks, among others. Equipment that is deployed in these communication systems is typically built to support standardized operating standards. These operating standards prescribe particular carrier frequencies, modulation types, baud rates, physical layer frame structures, MAC layer operations, link layer operations, etc. By complying with these operating standards, equipment interoperability is achieved.

In a cellular system, a regulatory body typically licenses a frequency spectrum for a corresponding geographic area (service area) that is used by a licensed system operator to provide wireless service within the service area. Based upon the licensed spectrum and the operating standards employed for the service area, the system operator deploys a plurality of carrier frequencies (channels) within the frequency spectrum that support the subscriber units within the service area. Typically, these channels are equally spaced across the licensed spectrum. The separation between adjacent carriers is defined by the operating standards and is selected to maximize the capacity supported within the licensed spectrum without excessive interference. In most cases, severe limitations are placed upon the amount of co-channel and adjacent channel interference that maybe caused by transmissions on a particular channel.

In cellular systems, a plurality of base stations is distributed across the service area. Each base station services wireless communications within a respective cell. Each cell may be further subdivided into a plurality of sectors. In many cellular systems, e.g., Global System for Mobile Communications (GSM) cellular systems, each base station supports forward link communications (from the base station to subscriber units) on a first set of carrier frequencies, and reverse link communications (from subscriber units to the base station) on a second set of carrier frequencies. The first set and second set of carrier frequencies supported by the base station are a subset of all of the carriers within the licensed frequency spectrum. In most, if not all, cellular systems, carrier frequencies are reused so that interference between base stations using the same carrier frequencies is minimized and system capacity is increased. Typically, base stations using the same carrier frequencies are geographically separated so that minimal interference results.

Traditional wireless mobile networks include Mobile Station Controllers (MSCs), Base Station Controllers (BSCs) and Base Transceiver Station (BTS) systems that jointly operate to communicate with mobile stations over a wireless communication link. Examples of common networks include the GSM networks, North American Time Division Multiple Access (TDMA) networks and Code Division Multiple Access (CDMA) networks. Extensive infrastructures (e.g., ANSI-41 or MAP-based networks) exist in the cellular wireless networks for tracking mobility, distributing subscriber profiles, and authenticating physical devices. In wireless mobile networks providing a facility to determine a mobile terminals geographic position, a network component commonly referred to as a Mobile Location Center (MLC) performs the location calculation. In GSM networks, the MLC is divided into two components; the Serving Mobile Location Center (SMLC) and the Gateway Mobile Location Center (GMLC).

To establish a wireless communication link in traditional wireless voice networks, an MSC communicates with a BSC to prompt the BTS (collectively “Base Station” or “BS”) to generate paging signals to a specified mobile station within a defined service area typically known as a cell or sector (a cell portion). The mobile station, upon receiving the page request, responds to indicate that it is present and available to accept an incoming call. Thereafter, the BS, upon receiving a page response from the mobile station, communicates with the MSC to advise it of the same. The call is then routed through the BS to the mobile station as the call setup is completed and the communication link is created. Alternatively, to establish a call, a mobile station generates call setup signals that are processed by various network elements in a synchronized manner to authenticate the user as a part of placing the call. The authentication process includes, for example, communicating with a Home Location Register (HLR) to obtain user and terminal profile information. The HLR is a central database that stores the permanent parameters of the user including additional services, the encryption keys for digital signal transmission, and the address of the Visitor Location Register (VLR) database. The VLR database contains information associated with the mobile station's current location including the serving BS.

The Wireless Communications and Public Safety Act (the 911 Act) was enacted to improve public safety by encouraging and facilitating the prompt deployment of a nationwide, seamless communications structure for emergency services. The 911 Act directs the FCC to make “911” the universal emergency number for all telephone services.

Emergency (911) calls from landlines provide the emergency dispatchers with the telephone number and the address of the caller thereby assisting emergency personnel in locating the emergency. As mobile stations became more widely used, an increasing number of emergency (911) calls are being made from mobile stations without a fixed address. Emergency call centers have recognized that relying upon the caller to describe their location caused a delay in service. Many mobile emergency (911) callers were unable to accurately describe their location, resulting in a further delay and, often times, a tragic outcome.

In 1996, the Federal Communications Commission (FCC) issued a report and order requiring all wireless carriers and mobile phone manufacturers to provide the capability for automatically identifying to emergency dispatchers the location from which a wireless call was made. Implementation is divided into two phases. Phase I requires wireless service providers and mobile phone manufacturers to report the telephone number of the mobile phone making the call as well as the base station controlling the mobile station which provided a general area from which the call was made. This information can be obtained from the network elements. Phase II of the FCC's Enhanced 911 (E-911) mandate states that by Oct. 1, 2002, wireless service providers must be able to pinpoint, by latitude and longitude, the location of a subscriber who calls emergency (911) from a mobile station. Wireless service providers were given the option of providing a network-based solution or a handset based solution. Wireless service providers who select a network-based solution are required to locate a mobile phone within 1000 meters 67% of the time.

One well-known method for locating a mobile station is triangulation. Signal power level or signal timing measurements between the mobile terminal and three or more base stations are used to triangulate. The signal power level or signal timing measurements are used to estimate the distance between each base station and the mobile terminal. The distances are plotted to determine a point of intersection. The point of intersection is the approximate transmitter location. For calculations using only signal power measurements, this method works only when the signal strength is relatively strong and not greatly affected by radio frequency (RF) fading, such as multipath interference. RF fading occurs when radiated signals encounter various obstacles that reflect and diffract the signal causing the received signal power level at the base station and mobile terminal to vary up to 30 dB. The requirement for a minimum of three base stations and the effect of RF fading limits the usefulness of triangulation.

Location techniques relying on measurements of timing differences, such as time difference of arrival (TDoA) or enhanced observed time difference (E-OTD), require signal timing measurements between the mobile terminal and three or more separate base stations. If the wireless networks base stations are not time synchronized then extra equipment is required at each base station to measure the timing difference between base stations in the network. If the standard wireless network is not capable of collecting signal timing measurements between three or more base stations and the mobile terminal, modification of the standard base station and optionally the handset are required. The modification of base stations and optionally handsets implies significant additional cost to wireless network operators.

The development of the Global Positioning System (GPS) by the U.S. Department of Defense (DoD) provides a means to fix a position using a system of orbiting satellites with orbital planes that guarantee that at least four satellites are visible at all times. This system provides location accuracy to within one meter for military systems possessing a Selective Availability (SA) algorithm to filter out the intentional noise added to the signal. GPS systems without SA are limited to an accuracy of approximately 100 meters. Widespread use of the GPS and the decision to discontinue the LORAN-C navigation system convinced the DoD to drop SA thereby allowing commercial GPS receivers to dramatically increase accuracy. The FCC recognized that GPS receivers could be incorporated into mobile phones when it made minor adjustments to the Phase II schedule. Using GPS to report location, however, requires the mobile user to upgrade existing hardware or to purchase new hardware.

There is a need in the art, therefore, for a method and apparatus to calculate a mobile phone's location that avoids the limitations of the prior art such as the requirement for three or more separate BTS and one that does not require a mobile station or network hardware change to satisfy Phase I requirements while limiting the impact to the users and to the network operators.

### BRIEF SUMMARY OF THE INVENTION

A method and apparatus are provided for reporting the latitude and longitude of a mobile station through the use of a network-only solution. Advantageously, the mobile station's location may be determined solely by a single base station transmitting in multiple sectors. The mobile station's range from a controlling base transceiver station is calculated from timing advance signal data. The mobile station bearing relative to the controlling base transceiver station is calculated from available collocated cell sector signal strength data. The mobile station is assigned an initial mobile station bearing equal to the radial center of a serving sector azimuth bearing of a tri-sectored or multi sectored cell site. The mobile station reports forward link pilot signal power measurements for the sectors collocated to the serving cell sector of the controlling base transceiver station. The mobile location center determines if a difference of the reported power measurements exceeds a specified level and mathematically adjusts the initial mobile station bearing by a calculated bearing step size. In one embodiment, a step size is equal to 30°, which is halfway between the center of the serving cell sector and an edge of the serving cell sector. In this embodiment the angle is changed from the center to 30° from the center if the power difference exceeds 15 dB for the reported power ratings. In another embodiment, multiple steps may be mapped to a corresponding multiple of reported power differences.

### BRIEF DESCRIPTION OF THE SEVERAL VIEWS OF THE DRAWINGS

A better understanding of the present invention can be obtained when the following detailed description of the preferred embodiment is considered with the following drawings, in which:

FIG. 1 is a functional block diagram of a communication network formed according to one embodiment of the present invention;

FIG. 2a is a functional block diagram of a cellular network cell having three cell sectors;

FIG. 2b is a functional block diagram of a cellular network cell having four cell sectors;

FIG. 3 is a flow chart of a method for estimating a mobile station bearing and location;

FIG. 4 is a flow chart of an alternate embodiment of the present invention showing a mobile station bearing adjustment method;

FIG. 5 is a functional block diagram that illustrates generation of a mobile station location according to one embodiment the present invention; and

FIG. 6 is a functional block diagram of a mobile location center in a cellular network according to the present invention.

### DETAILED DESCRIPTION OF THE INVENTION

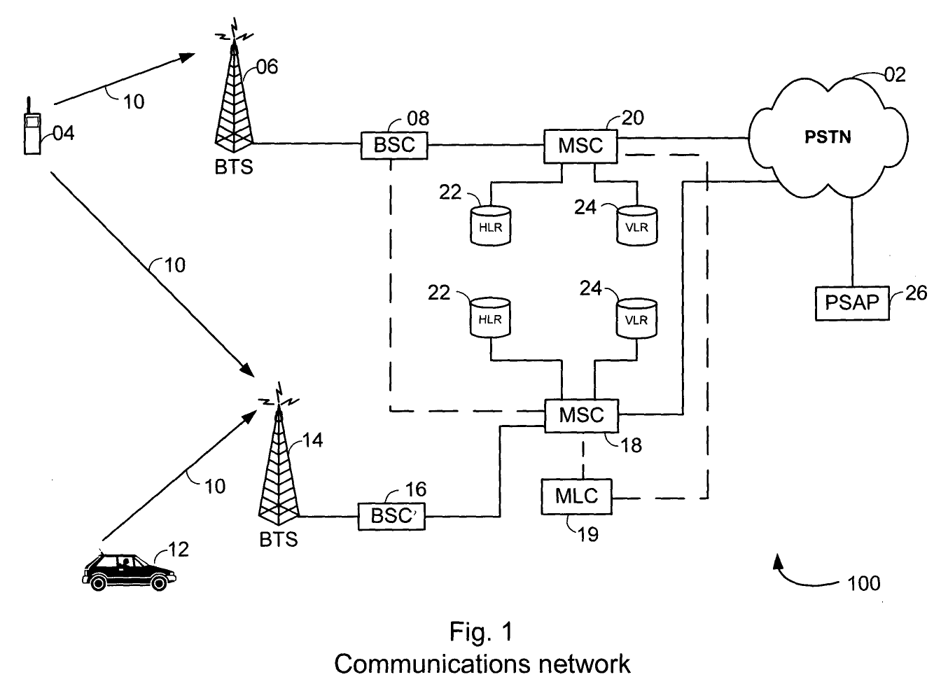

FIG. 1 is a functional block diagram of a communication network formed according to one embodiment of the present invention. As may be seen, a communication network 100 includes many elements that are coupled to operatively communicate with each other. The communication network 100 creates an ability for a mobile station operating in a time division multiple access network (TDMA) to communicate with a Public Switched Telephone Network (PSTN) 02 through a wireless communication link.

Along these lines, a mobile station 04 is located within a geographic area served by a Base Transceiver Station (BTS) 06 that is coupled to a Base Station Controller (BSC) 08. More specifically, mobile station 04 communicates with BTS 06 by way of a TDMA wireless communication network link shown generally at 10.

Similarly, a mobile station 12 is communicating with a BTS 14 in a separate geographic area served by BSC 16. More specifically, MS 12 communicates with BTS 14 by way of a TDMA wireless communication network link shown generally at 10. BSC 08 and BSC 16 may be served by a single mobile station controller (MSC), such as MSC 18, or by separate MSCs, namely 18 and 20. The serving MSC will access a home location register (HLR) 22 to authenticate a mobile station initiating a call. If the mobile station is out-of-network, data from the HLR will be copied into a visitors location register (VLR) 24 while the mobile station is in the geographic area served by the MSC.

Although the MSC collects mobile station data, it does not collect mobile station location information. Should the mobile station need to place an emergency call (911), the MSC will route the call through the PSTN to a public safety answering point (PSAP) 26. Emergency dispatchers receive the mobile station phone number and try to get a description of the location of the emergency in order to dispatch emergency services personnel. Many mobile station emergency callers have trouble accurately describing their location thereby slowing response time. The FCC recognized this problem and issued an order requiring all mobile carriers to provide automatic location identification (ALI) as part of the Enhanced 911 (E-911) act. To identify the location of the mobile station 04, the MSC 20 receives timing advance signal data and all sector signal strength data from the BTS 06, BSC 08 and mobile station 04 to the MLC 19. MLC 19 calculates the position of the mobile station 04 and returns this location to MSC 20 which passes the location to the PSAP 26 via the PSTN 02.

To identify the location of the mobile station 04 the MSC 18 also receives timing advance signal data and all sector signal strength data from the BTS 14, BSC 16 and mobile station 12 to the MLC 19. MLC 19 calculates the position of the mobile station 12 and returns this location to MSC 18, which passes the location to the PSAP 26 via the PSTN 02 (in the described embodiment).

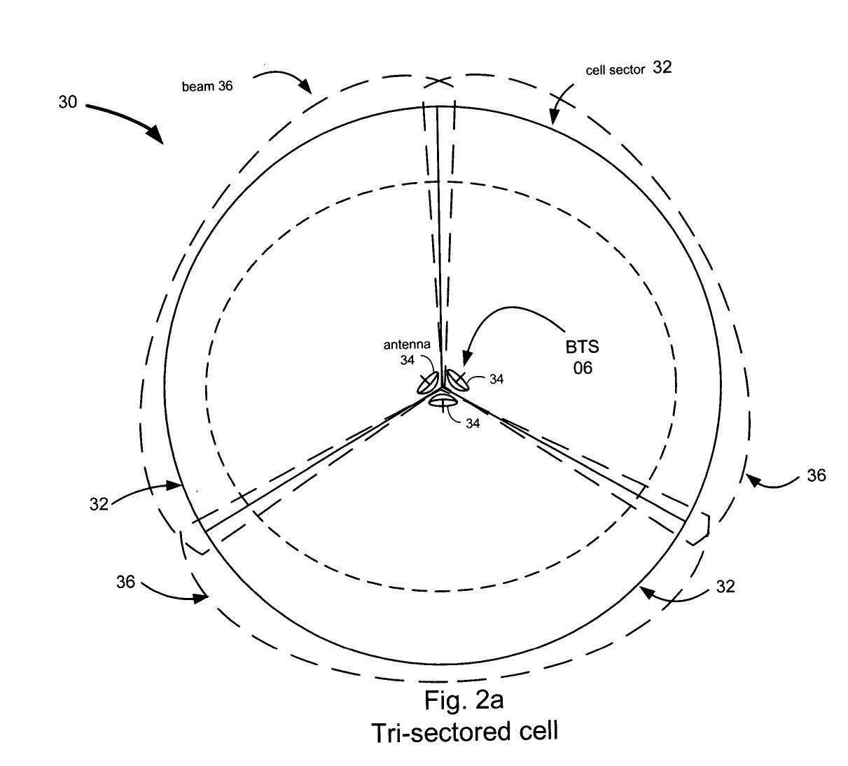

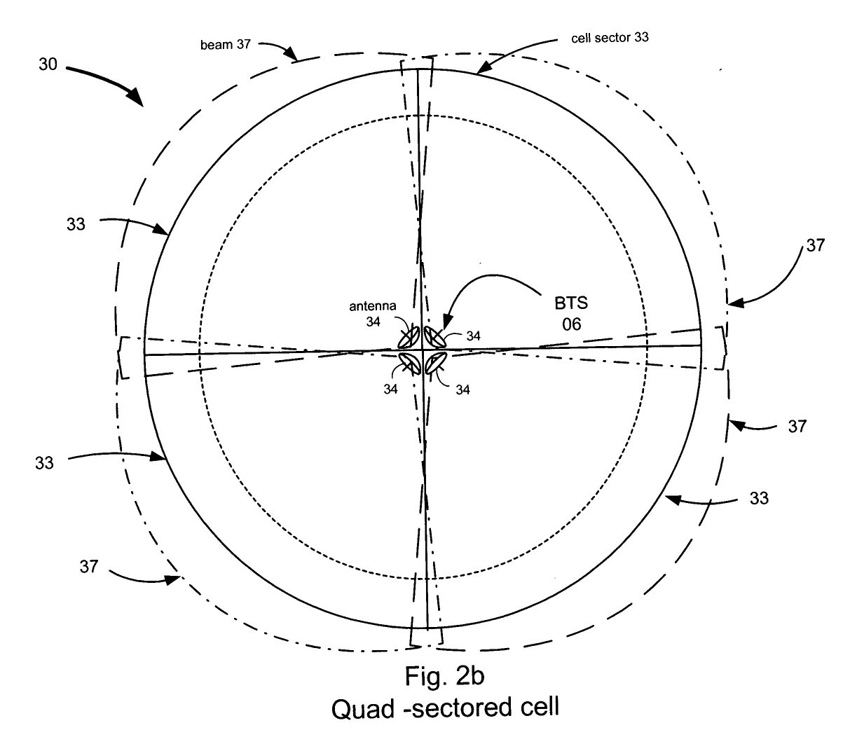

FIG. 2a is a functional block diagram of a tri-sectored cellular network cell. More specifically, a cell 30 includes three collocated cell sectors 32. Approximately in the center of cell 30 exists BTS 06 that includes an antenna 34 for each cell sector 32. The antennas 34 radiate a pattern to fill each cell sector 32 with minimal overlap into adjacent collocated cell sectors. As shown in FIG. 2, each sector covers 130° of arc in order to cover the entire cell. Beam 36 illustrates the main radiated pattern filling the cell sector 32 with limited overlap into adjacent collocated cell sectors. FIG. 2 is intended to illustrate a tri-sectored cell of a TDMA wireless network, but it is understood by one of average skill in the art that the radiated patterns formed by the sectored antennas are not as precise as illustrated. It is also understood by one of average skill in the art that mobile stations shall be able to receive signals from many adjacent cell sectors while not in the main radiated pattern of those cell sectors.

Collocated cell sectors are cell sectors hosted by the same BTS and may or may not share a boundary with other collocated cell sectors. Adjacent cell sectors are cell sectors that share a boundary and are not necessarily hosted by the same BTS. An adjacent collocated cell sector shares a boundary with another collocated cell sector.

Generally, the invention includes determining an approximate distance of the mobile station to the BTS and an approximate angle or bearing from the BTS to the mobile station. Accordingly, an estimate of the approximate distance is reflected by the dashed circle reflecting that a radius or distance from the BTS to the mobile station. The method for approximating the bearing or angle to the mobile station is discussed in greater detail below but generally includes comparing signal strengths from antennas for adjacent collocated cell sectors to approximately determine whether the mobile station is within an angular center of a cell sector or whether the mobile is at an angular end of the cell sector.

FIG. 2b is a functional block diagram of a quad-sectored cellular network cell. More specifically, a cell 30 includes four cell sectors 33. Approximately in the center of cell 30 exists BTS 06 that includes an antenna 34 for each cell sector 33. The antennas 34 radiate a pattern to fill each cell sector 33 with minimal overlap into adjacent collocated cell sectors. As shown in FIG. 2b, each sector covers 100° of arc in order to cover the entire cell. Beam 37 illustrates the radiated pattern filling the cell sector 33 with limited overlap into adjacent collocated cell sectors. FIG. 2b is intended to illustrate a quad-sectored cell of a TDMA wireless network, but it is understood by one of average skill in the art that the radiated patterns formed by the sectored antennas are not as precise as illustrated. As may be seen from examining FIG. 2b, there are many different embodiments of the invention and that the invention is not limited to tri-sectored cells.

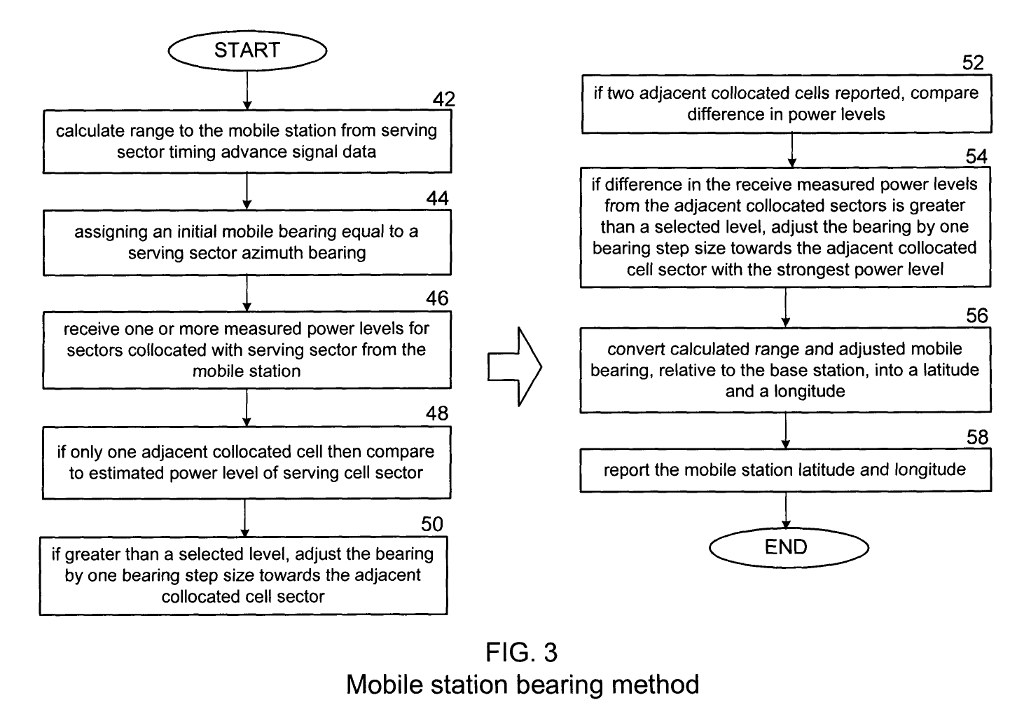

FIG. 3 is a flow chart of a method for estimating a mobile station's bearing and location. This embodiment assumes a tri-sectored cell but the principle is extensible to cells with more than three sectors. The range between the mobile station and serving BTS is calculated from serving sector timing advance signal data (step 42). An initial mobile station bearing is assigned equal to a serving sector azimuth bearing (step 44), which is centered on a serving sector arc (130° in the described embodiment). One or more measured power levels for collocated cell sectors are received from the mobile station (step 46) reflecting the measured strength of the collocated cell sectors'pilot signals. If only one adjacent collocated cell is reported then this is compared to an estimated serving cell sector power level (step 48). If the adjacent collocated cell sector power level is greater than the serving cell sector estimated power level by a selected amount, the initial mobile station bearing is adjusted a bearing step size towards the adjacent collocated cell sector (step 50). If two adjacent collocated cells are reported, the difference between the first and second adjacent collocated cell sector power measurements is calculated and if less than a selected level, the mobile station is determined to be approximately an equal distance between the first and second adjacent sectors and is, therefore, centered in the serving cell sector arc (in this embodiment 130°) (step 52). If the difference is greater than the selected level, the initial mobile station bearing is adjusted plus or minus a bearing step size (step 54). The mobile station bearing will be adjusted toward the adjacent sector with the strongest measured power level. The mobile station range and adjusted bearing, relative to the base station, are converted into latitude and longitude (step 56), which is reported back to the public safety answering point (PSAP) (step 58).

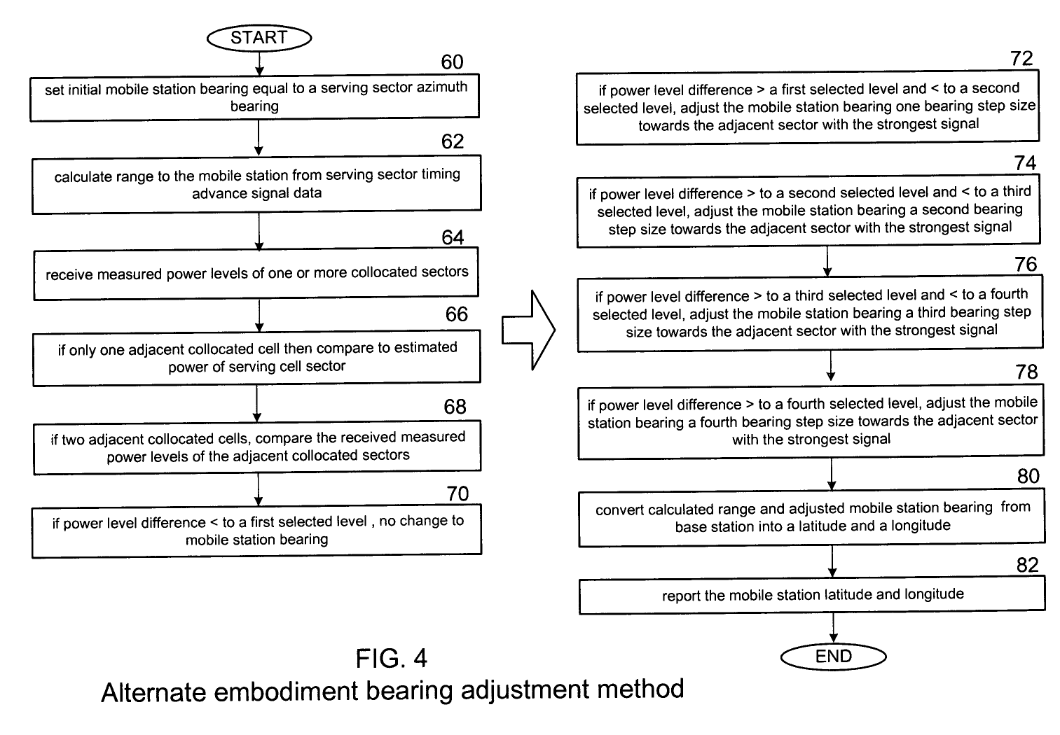

FIG. 4 is a flow chart of an alternate embodiment of the present invention showing a mobile station bearing adjustment method. This embodiment assumes a tri-sectored cell but the principle is extensible to cells with more than three sectors. The initial mobile station bearing is set equal to a serving sector azimuth bearing (step 60). The range is calculated from serving sector timing advance signal data (step 62). Power level measurements for one or more collocated cell sectors are received (step 64). If only one adjacent collocated cell is reported then this is compared to an estimated serving cell power level (step 66). If two adjacent collocated cells sectors are reported then these are compared (step 68). If the absolute (unsigned) value of the power level comparison is less than a first selected level (step 70), the mobile station is approximately equal distance from the first and second adjacent sectors and therefore centered in a serving sector arc (in this embodiment 130°) and the mobile station location can be reported. If, however, the power level comparison is greater than the first selected level but less than a second selected level, the mobile station bearing is adjusted one bearing step size towards the adjacent sector with the strongest signal (step 72). If the comparison yields a difference greater than the second selected level, the mobile station bearing is adjusted to a second bearing step size (step 74). Similarly, the bearing step size may be adjusted to a third bearing step size for a third selected level (step 76) or to a fourth bearing step size for a fourth selected level (step 78). The estimated mobile station bearing and known range are converted to a latitude and a longitude (step 80) and then the mobile station latitude and longitude is reported back to the PSAP (step 82).

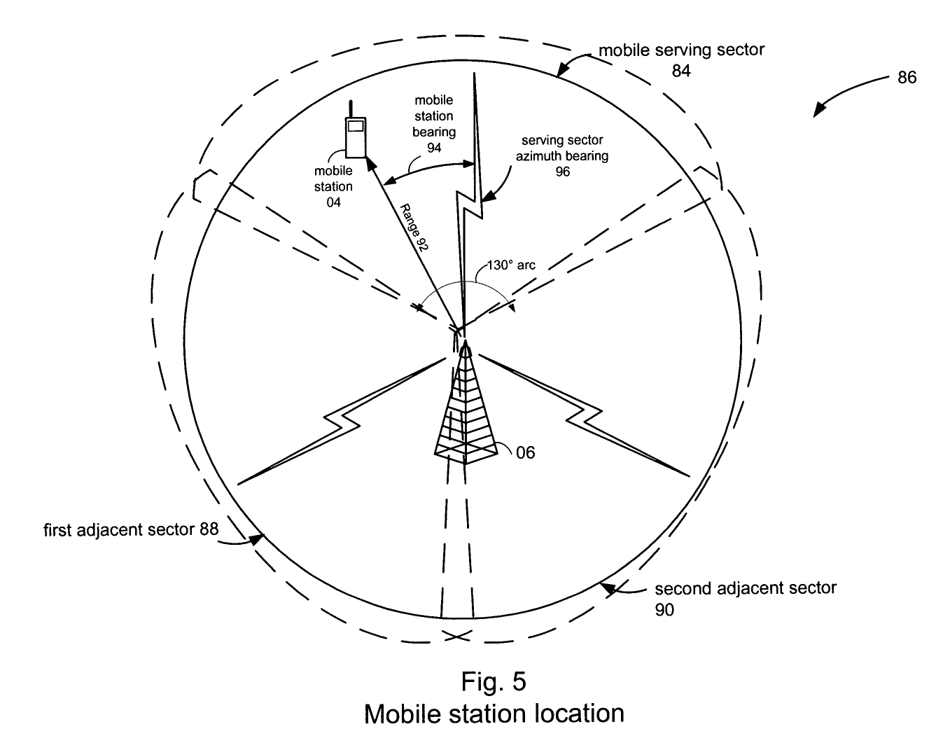

FIG. 5 is a functional block diagram that illustrates generation of a mobile station location according to one embodiment the present invention. A base transceiver station (BTS) 06 location (latitude and longitude) is accurately known. Therefore, to determine or estimate a mobile station location requires only determining or estimating the position (range and bearing) of the mobile station relative to the BTS.

Mobile station 04 generally is served by an antenna in the cell sector within which it is located, mobile serving sector 84, of a tri-sectored cell 86. A first adjacent collocated sector 88 and a second adjacent collocated sector 90 represent the other two sectors of the tri-sectored cell.

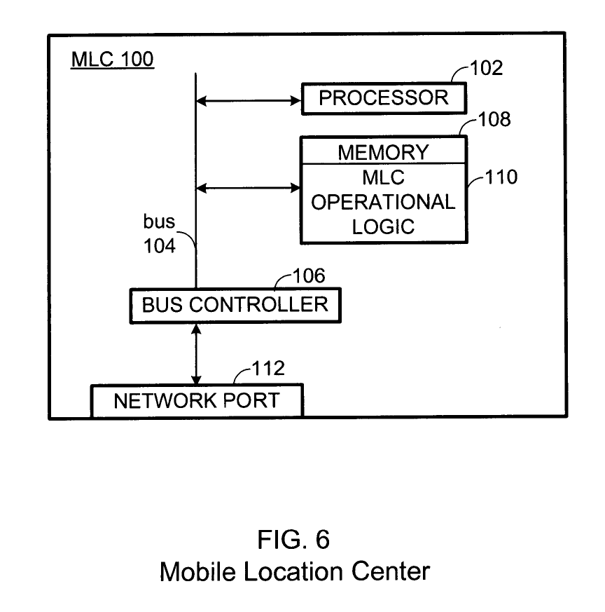

When mobile station 04 places an emergency call, mobile location center (MLC) processor (not shown here in FIG. 5) executes computer instructions stored in memory 108 of FIG. 6 to calculate a range (distance) 92 from the BTS to the mobile station. To calculate range, mobile location center (not shown) retrieves timing advance signal data, which is used to synchronize time slots in a TDMA network. As is known by those of average skill in the art, the timing advance signal data is a function of the distance a mobile station signal must travel and, therefore, is easily converted to distance. To calculate mobile station bearing 94, the mobile station is first assigned an initial mobile station bearing equal to a serving sector azimuth bearing 96, which is the radial center of the mobile serving sector 130° arc. The MLC processor retrieves network measurement record data from the mobile station for all sectors the mobile station can see. The network measurement record data is compiled from reported cell sector pilot signal strength measurements from the mobile station. The MLC processor next compares the retrieved measured power levels. If only one adjacent collocated cell sector is reported, then the MLC processor compares this value to an estimated power level for the serving cell sector. If the adjacent collocated cell sector power level is greater by a selected level (in this embodiment 18 dB) then the mobile station's initial estimated bearing in the cell sector center is changed by a selected bearing step size toward the adjacent collocated cell sector. In one embodiment, the bearing step size is 30°.

If two adjacent collocated cell sectors are reported, the first adjacent collocated sector and the second adjacent collocated sector are compared. If the result of the comparison is favorable, i.e., the power levels are equal to within a specified amount (e.g., 15 dB), then the mobile station is estimated to be equal distance from the first and second adjacent sectors. The range and bearing data is converted to a latitude and longitude by techniques known to those with average skill in the art.

If the results of the comparison show that the difference of recorded cell sector pilot signal strength exceed a selected level, the mobile station's initial estimated bearing in the cell sector center is changed by a selected bearing step size toward the adjacent sector with the strongest signal. The bearing step size is a value determined by signal conditions, environmental conditions and simulation. In one embodiment, the bearing step size is 30°. Only one iteration is required when using a bearing step size of 30° since another step of 30° in the same direction would place the mobile station bearing on the border between the serving sector and the adjacent sector. The bearing step size of 30° is used to adjust the original bearing estimate when, in the described embodiment, the difference in reported pilot signal strength measurements exceeds 15 dB.

In an alternate embodiment, multiple smaller bearing step sizes are used for corresponding multiple differences in pilot signal strength measurements from the adjacent cell sectors.

FIG. 6 is a functional block diagram that illustrates one embodiment of a mobile location center (MLC). Referring now to FIG. 6, MLC 100 includes a processor 102 that is coupled to communicate over a bus 104. A bus controller 106 controls communications over bus 104. A memory 108 further is coupled to bus 104 and includes computer instructions that are retrieved by processor 102 over bus 104 for execution. The computer instructions within memory 108 define the operational logic of MLC 100. For example, memory 108 includes a memory portion 110 that includes computer instructions that define the MLC operational logic. The computer instructions within memory portion 110 define operational logic that is described by the block diagrams and flowcharts and other descriptions herein of the present embodiment of the invention relating to generation of an automatic location identification (ALI) for a mobile station. Bus controller 106 further is coupled to a network port 112 through which MLC 100 communicates with external devices. Thus, when processor 102 retrieves the computer instructions stored within memory portion 110 and executes them to determine that it should generate an ALI, processor 102 generates the ALI and transmits it over bus 104 through bus controller 106 and out network port 112 for transmission to an MSC for transmission to the PSAP.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

What is claimed is:

1. A mobile location center (MLC), comprising:
a processor;
a bus coupled to the processor for transmitting computer instructions and control signals to and from the processor within the base station;
memory coupled to the bus, the memory including computer instructions that define operational logic for calculating a mobile station location; and
wherein the computer instructions prompt the processor to retrieve and store timing advance data and signal strength data to determine a distance and an approximate mobile station bearing relative to a serving sector azimuth bearing as a function of the timing advance data and signal strength data.

2. The MLC of claim 1 wherein the base station is sectored.

3. The MLC of claim of claim 2 wherein each sector of the sectored base station covers one of a 130° arc (for a tri-sectored cell), a 100° arc (for a quad-sectored cell) or a 70° arc (for a six-sectored cell).

4. The MLC of claim 3 wherein one sector of the sectored base station is a mobile station serving cell sector.

5. The MLC of claim 4 wherein a radial center of the mobile serving cell sector arc defines the serving sector azimuth bearing.

6. The MLC of claim 5 wherein the mobile station bearing is initially set equal to the serving cell sector azimuth bearing.

7. The MLC of claim 5 wherein the mobile station bearing is adjusted according to relative signal strength of collocated cell sectors.

8. The MLC of claim 1 wherein the mobile station bearing is adjusted no more than one increment.

9. The MLC of claim 1 wherein the mobile station bearing is adjusted to one of two increment amounts.

10. The MLC of claim 1 wherein the computer instructions stored within the memory defines operational logic to prompt the processor to retrieve network measurement record data for a first adjacent sector and for a second adjacent sector, said first and second adjacent sectors being collocated with the mobile serving sector.

11. The MLC of claim 10 wherein the retrieved network measurement record data contains power measurements of the adjacent sectors pilot signals.

12. The MLC of claim 11 wherein the computer instructions stored within the memory defines operational logic to prompt the processor to compare the adjacent sectors power measurements and change the mobile station bearing by a selected bearing step size if the power difference is greater than a selected level.

13. The MLC of claim 12 wherein the selected level difference is dynamically adjusted based on signal conditions and environmental conditions.

14. The MLC of claim 13 wherein the selected level difference is 15 dB.

15. The MLC of claim 12 wherein the selected bearing step size is dynamically adjusted based on signal conditions and environmental conditions.

16. The MLC of claim 15 wherein the selected bearing step size (increment) is 30 degrees.

17. The MLC of claim 12 wherein the mobile station bearing is adjusted by one bearing step size towards an adjacent sector with the strongest signal.

18. The MLC of claim 1 wherein the serving mobile location center is formed to operate as a time division multiple access network.

19. A method for determining a mobile station location in a serving sector characterized by an arc of a specified size, comprising:
calculating a range from a serving base station to a mobile station from serving sector timing advance signal data;
assigning an initial mobile station bearing equal to a serving sector azimuth bearing;
receiving a plurality of measured power levels for first and second adjacent sectors from the mobile station;
comparing the received measured power levels of the first and second adjacent sectors;
adjusting the initial mobile station bearing plus or minus a bearing step size if a difference in the received measured power levels for the first and second adjacent sectors is greater than a selected level;
converting calculated range and adjusted mobile station bearing relative to a base station into latitude and longitude; and
reporting the mobile station location latitude and longitude.

20. The method of claim 19 wherein the bearing step size is dynamic based on environmental variables.

21. The method of claim 20 wherein the nominal bearing step size is approximately one-fourth of the serving sector arc.

22. The method of claim 19 wherein the selected level is a function of the calculated range.

23. The method of claim 22 wherein the nominal selected level is 15 dB.

24. A method for determining a mobile station location comprising:
calculating a mobile station range from a serving base station;
assigning a mobile station bearing with respect to a base station azimuth bearing based upon reported pilot signal strength values from adjacent cell sectors;
converting calculated mobile station range and mobile station bearing into latitude and longitude; and
reporting the mobile station location.
